(19) United States
(12) Patent Application Publication
(10) Pub. No.: US 2018/0311687 A1
(43) Pub. Date: Nov. 1, 2018

(54) Glass atomizer and production method thereof

(71) Applicant: Beijing shuguangming Electronic lighting Instrument Co., Ltd., Beijing (CN)

(72) Inventor: Sen Li, Beijing (CN)

(73) Assignee: Beijing shuguangming Electronic lighting Instrument Co., Ltd.

(21) Appl. No.: 16/021,225

(22) Filed: Jun. 28, 2018

(30) Foreign Application Priority Data
Jul. 1, 2017 (CN) 201710528986.3

(51) Int. Cl. B05B 7/06; C03B 23/11; C03B 23/047; C03B 23/207; C03B 23/08

(52) U.S. Cl. CPC B05B 7/06; C03B 23/11; C03B 23/08; C03B 23/207; C03B 23/0473

(57) ABSTRACT

A glass atomizer includes an atomizer housing, wherein: a diameter of the atomizer housing is 5.8-6.2 mm; a nozzle is formed at a top part of the atomizer housing; an outlet of the nozzle has a diameter of 2.4-2.5 mm; a limiting convex member is arranged at a bottom part of the atomizer housing; a conical hollow connection member is formed at an inner wall of the bottom part of the atomizer housing; a top part of the connection member extends upward and forms an atomizer core tube; the atomizer core tube and the atomizer housing are concentric; an inlet tube is integrally formed at a side of the atomizer housing; and a groove is opened at an outer wall of the inlet tube.

### CROSS REFERENCE OF RELATED APPLICATION

The application claims priority under 35 U.S.C. 119(a-d) to CN C201710528986.3, filed Jul. 1, 2017.

### BACKGROUND OF THE PRESENT INVENTION

### Field of Invention

The present invention relates to a technical field of fine machining, and more particularly to a glass atomizer and a production method thereof.

### Description of Related Arts

The atomic emission spectrometer is a scientific instrument which decomposes the light having the complicated component into the spectral lines. The atomic emission spectrometer is sealed in a constant-temperature case, and has the compact design and simple operation. The movement and operation of the atomic emission spectrometer can be completed by just one person. The atomic emission spectrometer is equipped with the photomultiplier having the ultrahigh sensitivity, and enables the dynamic range of the detector to be able to identify the smallest difference of the component in the full measuring range. The atomic emission spectrometer has various types, such as the spark source atomic emission spectrometer, the photoelectric atomic emission spectrometer, the handheld spectrometer, the portable spectrometer, the energy dispersion spectrometer, and the vacuum atomic emission spectrometer. The atomic emission spectrometer is widely applied in casting, steel, metal recovery and smelting, military industry, aerospace, electric power, chemical industry, colleges and universities, and sectors of commodity inspection and quality testing.

The atomizer is an important part of the atomic emission spectrometer and is applied for atomizing the liquid sample. Because the atomic emission spectrometer has the advantages of small sample consumption amount and high sensitivity, the atomic emission spectrometer has the greatly high requirement on the atomizer. Thus, the present invention provides a glass atomizer having the high precision and good atomization effect and a production method thereof.

### SUMMARY OF THE PRESENT INVENTION

An object of the present invention is to provide a glass atomizer and a production method thereof, so as to solve problems existing in prior art.

In order to accomplish the above object, following technical solutions are provided by the present invention.

A glass atomizer comprises an atomizer housing, wherein: a diameter of the atomizer housing is 5.8-6.2 mm; a nozzle is formed at a top part of the atomizer housing; an outlet of the nozzle has a diameter of 2.4-2.5 mm; a limiting convex member is arranged at a bottom part of the atomizer housing; a conical hollow connection member is formed at an inner wall of the bottom part of the atomizer housing; a top part of the connection member extends upward and forms an atomizer core tube; the atomizer core tube and the atomizer housing are concentric; an inlet tube is integrally formed at a side of the atomizer housing; and a groove is opened at an outer wall of the inlet tube.

Preferably, the atomizer housing has a diameter of 6 mm and a length of 50 mm; the outlet of the nozzle has a diameter of 2.5 mm.

Preferably; a working pressure of the glass atomizer is 0.1 MPa, and a flow amount of the glass atomizer is 260-320 ml/min.

A method for producing a glass atomizer comprises steps of:

(1), producing an atomizer housing, particularly comprising steps of: fixing two ends of a first glass tube at a lathe, wherein a rotation speed of the lathe is 120 r/min; heating a middle part of the first glass tube to a softening state through a blowtorch; pulling the two ends of the first glass tube by the lathe, so that the middle part of the first glass tube forms a thin neck part; cutting the first glass tube from the thin neck part, and obtaining two atomizer housings;

(2), producing an atomizer core tube, particularly comprising steps of: fixing two ends of a second glass tube at the lathe; starting the lathe; heating the second glass tube through the blowtorch; pulling the two ends of the second glass tube by the lathe, so that a middle part of the second glass tube becomes thinner and longer after pulling; according to a specification of the glass atomizer, cutting the second glass tube from the middle part, and obtaining the atomizer core tube;

(3), assembling the atomizer housing with the atomizer core tube, particularly comprising steps of: fixing a top part of the atomizer housing at a first head of the lathe; and fixing a bottom part of the atomizer core tube at a second head of the lathe; starting the lathe, and making the two heads of the lathe close to each other, so that the atomizer core tube is inserted into the atomizer housing; heating a bottom part of the atomizer housing to a softening state through the blowtorch, and then removing the blowtorch; and cooling the bottom part of the atomizer housing, wherein after the bottom part of the atomizer housing is cooled, the atomizer housing and the atomizer core tube are integrated together;

(4), calibrating concentricity of the atomizer housing and the atomizer core tube, particularly comprising steps of: vertically fixing the atomizer housing under a microscope of 16-18 times magnification; heating the bottom part of the atomizer housing to the softening state through the blowtorch, and then removing the blowtorch; observing the top part of the atomizer housing through the microscope, and meanwhile adjusting a position of the atomizer housing, so as to enable the atomizer housing and the atomizer core tube to be concentric;

(5), mounting an inlet tube, particularly comprising steps of: opening a through-hole at a side wall of the atomizer housing, wherein a diameter of the through-hole is consistent with that of the inlet tube; mounting the inlet tube on the atomizer housing through the through-hole; softening a joint between the inlet tube and the atomizer housing through the blowtorch; cooling the joint, wherein after the joint is cooled, the inlet tube and the atomizer housing are integrated together; and obtaining an atomizer semi-finished product; and

(6), testing the atomizer semi-finished product through ventilation; according to an atomization effect, adjusting a distance between a top end of the atomizer core tube and a nozzle outlet; processing the atomizer semi-finished product with machining and cutting; and obtaining a finished product of the glass atomizer.

Preferably, in the step (1), the first glass tube is heated by the blowtorch for 15-25 s; the first glass tube has a length of 10 cm and a diameter of 6 mm; and a pull distance of the lathe is 5 mm.

The present invention has following beneficial effects.

The glass atomizer provided by the present invention has the high concentricity and good atomization effect, and is applicable to the precise analysis instruments such as the inductively coupled plasma. The production method provided by the present invention has the high precision machining and high qualification rate, and is easy for large-scale production.

### BRIEF DESCRIPTION OF THE DRAWINGS

With the accompanying drawings and the following detailed description thereof, the present invention and the advantages thereof can be better understood. The accompanying drawings are for providing further understanding of the present invention and belong to a part of the present invention; the embodiments and the illustration thereof are for explaining the present invention, not for limiting the present invention improperly.

FIG. 1 is a structural sketch view of a glass atomizer according to a preferred embodiment of the present invention.

FIG. 2 is a sketch view of a pull process of an atomizer housing according to the preferred embodiment of the present invention.

FIG. 3 is a sketch view of the atomizer housing according to the preferred embodiment of the present invention.

FIG. 4 is a sketch view of a pull process of an atomizer core tube according to the preferred embodiment of the present invention.

FIG. 5 is a sketch view of the atomizer core tube according to the preferred embodiment of the present invention.

### DETAILED DESCRIPTION OF THE PREFERRED EMBODIMENT

With accompanying drawings, technical solutions of the preferred embodiment of the present invention are clearly and completely described as follows.

### Preferred Embodiment

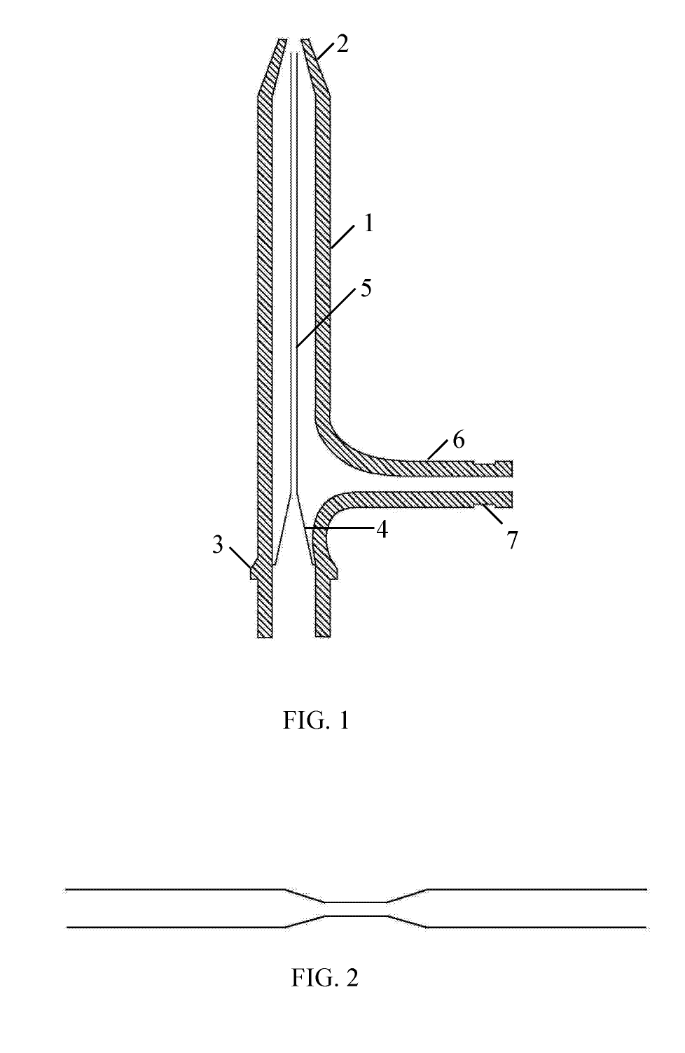

As shown in FIG. 1, a glass atomizer comprises an atomizer housing 1, wherein: a diameter of the atomizer housing 1 is 5.8-6.2 mm; a nozzle 2 is formed at a top part of the atomizer housing 1; an outlet of the nozzle 2 has a diameter of 2.4-2.5 mm; a limiting convex member 3 is arranged at a bottom part of the atomizer housing 1; a conical hollow connection member 4 is formed at an inner wall of the bottom part of the atomizer housing 1; a top part of the connection member 4 extends upward and forms an atomizer core tube 5; the atomizer core tube 5 and the atomizer housing 1 are concentric; an inlet tube 6 is integrally formed at a side of the atomizer housing 1; and a groove 7 is opened at an outer wall of the inlet tube 6. A working pressure of the glass atomizer is 0.1 MPa, a flow amount of the glass atomizer is 260-320 ml/min, and a liquid lifting amount is 0.8-1.2 ml/min.

A method for producing a glass atomizer comprises steps of:

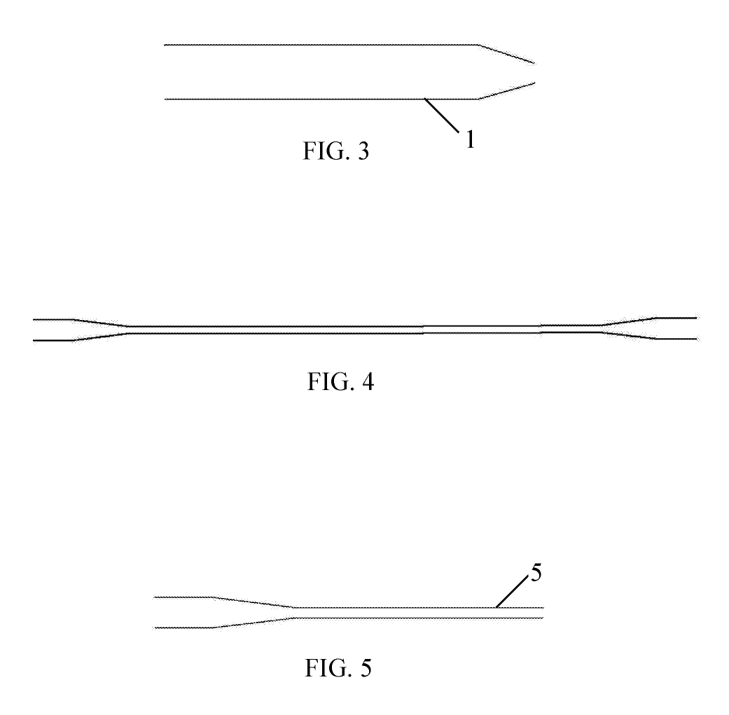

(1), producing an atomizer housing, particularly comprising steps of: fixing two ends of a first glass tube at a lathe, wherein a rotation speed of the lathe is 120 r/min; heating a middle part of the first glass tube to a softening state through a blowtorch; pulling the two ends of the first glass tube by the lathe, so that the middle part of the first glass tube forms a thin neck part (as shown in FIG. 2); cutting the first glass tube from the thin neck part, and obtaining two atomizer housings (as shown in FIG. 3); wherein the step (1) can be completed by a digital controlled glass lathe, so as to increase a machining accuracy;

(2), producing an atomizer core tube, particularly comprising steps of: fixing two ends of a second glass tube at the lathe; starting the lathe; heating the second glass tube through the blowtorch; pulling the two ends of the second glass tube by the lathe, so that a middle part of the second glass tube becomes thinner and longer after pulling (as shown in FIG. 4); according to a specification of the glass atomizer, cutting the second glass tube from the middle part, and obtaining the atomizer core tube (as shown in FIG. 5);

(3), assembling the atomizer housing with the atomizer core tube, particularly comprising steps of: fixing a top part of the atomizer housing at a first head of the lathe, and fixing a bottom part of the atomizer core tube at a second head of the lathe; starting the lathe, and making the two heads of the lathe close to each other, so that the atomizer core tube is inserted into the atomizer housing; heating a bottom part of the atomizer housing to a softening state through the blowtorch, and then removing the blowtorch; and cooling the bottom part of the atomizer housing, wherein after the bottom part of the atomizer housing is cooled, the atomizer housing and the atomizer core tube are integrated together;

(4), calibrating concentricity of the atomizer housing and the atomizer core tube, particularly comprising steps of: vertically fixing the atomizer housing under a microscope of 16-18 times magnification; heating the bottom part of the atomizer housing to the softening state through the blowtorch, and then removing the blowtorch; observing the top part of the atomizer housing through the microscope, and meanwhile adjusting a position of the atomizer housing, so as to enable the atomizer housing and the atomizer core tube to be concentric;

(5), mounting an inlet tube, particularly comprising steps of: opening a through-hole at a side wall of the atomizer housing, wherein a diameter of the through-hole is consistent with that of the inlet tube; mounting the inlet tube on the atomizer housing through the through-hole; softening a joint between the inlet tube and the atomizer housing through the blowtorch; cooling the joint, wherein after the joint is cooled, the inlet tube and the atomizer housing are integrated together; and obtaining an atomizer semi-finished product; and

(6), testing the atomizer semi-finished product through ventilation; according to an atomization effect, adjusting a distance between a top end of the atomizer core tube and a nozzle outlet; processing the atomizer semi-finished product with machining and cutting; and obtaining a finished product of the glass atomizer.

Furthermore, in the step (1), the first glass tube is heated by the blowtorch for 15-25 s; the first glass tube has a length of 10 cm and a diameter of 6 mm; and a pull distance of the lathe is 5 mm.

What is claimed is:

1. A glass atomizer, comprising an atomizer housing, wherein: a diameter of the atomizer housing is 5.8-6.2 mm; a nozzle is formed at a top part of the atomizer housing; an outlet of the nozzle has a diameter of 2.4-2.5 mm; a limiting convex member is arranged at a bottom part of the atomizer housing; a conical hollow connection member is formed at an inner wall of the bottom part of the atomizer housing; a top part of the connection member extends upward and forms an atomizer core tube; the atomizer core tube and the atomizer housing are concentric; an inlet tube is integrally formed at a side of the atomizer housing; and a groove is opened at an outer wall of the inlet tube.

2. The glass atomizer, as recited in claim 1, wherein: the atomizer housing has a diameter of 6 mm and a length of 50 mm; the outlet of the nozzle has a diameter of 2.5 mm.

3. The glass atomizer, as recited in claim 1, wherein: a working pressure of the glass atomizer is 0.1 MPa, a flow amount of the glass atomizer is 260-320 ml/min, and a liquid lifting amount is 0.8-1.2 ml/min.

4. A method for producing a glass atomizer; comprising steps of:
(1), producing an atomizer housing, particularly comprising steps of: fixing two ends of a first glass tube at a lathe, wherein a rotation speed of the lathe is 120 r/min; heating a middle part of the first glass tube to a softening state through a blowtorch; pulling the two ends of the first glass tube by the lathe, so that the middle part of the first glass tube forms a thin neck part; cutting the first glass tube from the thin neck part, and obtaining two atomizer housings;
(2), producing an atomizer core tube, particularly comprising steps of: fixing two ends of a second glass tube at the lathe; starting the lathe; heating the second glass tube through the blowtorch; pulling the two ends of the second glass tube by the lathe, so that a middle part of the second glass tube becomes thinner and longer after pulling; according to a specification of the glass atomizer, cutting the second glass tube from the middle part, and obtaining the atomizer core tube;
(3), assembling the atomizer housing with the atomizer core tube, particularly comprising steps of: fixing a top part of the atomizer housing at a first head of the lathe, and fixing a bottom part of the atomizer core tube at a second head of the lathe; starting the lathe, and making the two heads of the lathe close to each other, so that the atomizer core tube is inserted into the atomizer housing; heating a bottom part of the atomizer housing to a softening state through the blowtorch, and then removing the blowtorch; and cooling the bottom part of the atomizer housing; wherein after the bottom part of the atomizer housing is cooled, the atomizer housing and the atomizer core tube are integrated together;
(4), calibrating concentricity of the atomizer housing and the atomizer core tube, particularly comprising steps of: vertically fixing the atomizer housing under a microscope of 16-18 times magnification; heating the bottom part of the atomizer housing to the softening state through the blowtorch, and then removing the blowtorch; observing the top part of the atomizer housing through the microscope, and meanwhile adjusting a position of the atomizer housing, so as to enable the atomizer housing and the atomizer core tube to be concentric;
(5), mounting an inlet tube, particularly comprising steps of: opening a through-hole at a side wall of the atomizer housing, wherein a diameter of the through-hole is consistent with that of the inlet tube; mounting the inlet tube on the atomizer housing through the through-hole; softening a joint between the inlet tube and the atomizer housing through the blowtorch; cooling the joint, wherein after the joint is cooled, the inlet tube and the atomizer housing are integrated together; and obtaining an atomizer semi-finished product; and
(6), testing the atomizer semi-finished product through ventilation; according to an atomization effect, adjusting a distance between a top end of the atomizer core tube and a nozzle outlet; processing the atomizer semi-finished product with machining and cutting; and obtaining a finished product of the glass atomizer.

5. The method for producing the glass atomizer, as recited in claim 4, wherein: in the step (1), the first glass tube is heated by the blowtorch for 15-25 s; the first glass tube has a length of 10 cm and a diameter of 6 mm; and a pull distance of the lathe is 5 mm.
